(19) United States
(12) Patent Application Publication
(10) Pub. No.: US 2008/0278424 A1
(43) Pub. Date: Nov. 13, 2008

(54) DISPLAY PANEL

(75) Inventors: Hee-Joon KIM, Cheonan-si (KR); Jeong-Eun PARK, Asan-si (KR); Yong-Woo LEE, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/932,357

(22) Filed: Oct. 31, 2007

(30) Foreign Application Priority Data
Nov. 23, 2006 (KR) 2006-116487

(51) Int. Cl. G09G 3/36

(52) U.S. Cl. 345/92

(57) ABSTRACT

In a display panel including a plurality of pixels, each pixel includes a first thin film transistor, first and second liquid crystal capacitors, a coupling capacitor, and a discharge circuit. The first liquid crystal capacitor is connected to a data line through the first thin film transistor. The second liquid crystal capacitor is connected in parallel to the first liquid crystal capacitor through the coupling capacitor. The discharge circuit is connected between the coupling capacitor and the second liquid crystal capacitor, and it discharges charges stored in the second liquid crystal capacitor.

### CROSS-REFERENCE TO RELATED APPLICATION

This application claims priority from and the benefit of Korean Patent Application No. 10-2006-116487, filed on Nov. 23, 2006, which is hereby incorporated by reference for all purposes as if fully set forth herein.

### BACKGROUND OF THE INVENTION

1. Field of the Invention

The present invention relates to a display panel. More particularly, the present invention relates to a display panel that may be capable of efficiently discharging charges stored in pixels.

2. Discussion of the Background

In general, a liquid crystal display (LCD) includes an LCD panel. The LCD panel includes a thin film transistor substrate, on which a thin film transistor is formed, a color filter substrate, on which a color filter is formed, and a liquid crystal layer between the thin film transistor substrate and the color filter substrate. Since the LCD panel is not self-emissive, it may include a backlight unit arranged behind the thin film transistor substrate to irradiate light thereto. The transmittance of light irradiated from the backlight unit is adjusted according to alignment states of the liquid crystal layer.

An LCD may be thin, lightweight, and consume little power, but a large LCD may be difficult to manufacture, its contrast ratio could be improved, and its viewing angle could be widened.

In order to widen the LCD's viewing angle, a Patterned Vertically Aligned (PVA) mode LCD has been developed. According to the PVA LCD, cutting patterns are formed in both a pixel electrode and a common electrode, and the tilt direction of the liquid crystal molecules is adjusted using a fringe field formed by the cutting patterns, thereby improving the viewing angle.

In the PVA LCD, the phase retardation of light passing through liquid crystal molecules may vary significantly depending on the viewing angle between the front and lateral side of the LCD. Therefore, the brightness of a low gray scale may increase significantly in the lateral side of the LCD, thereby deteriorating visibility and lowering contrast ratio. In order to solve this problem, a Super-PVA (SPVA) LCD has been developed. According to the SPVA LCD, a pixel electrode is divided into a first section, to which a data voltage is directly applied, and a second section, which is electrically floated relative to the first section.

When an LCD panel turns off, a ground voltage is applied thereto through gate lines. Thus, the ground voltage is also applied to the gate electrode of a thin film transistor. In this case, since an electric current of about 10 pA to 1 nA may flow in the thin film transistor, charges stored in pixels may be discharged to the exterior through data lines in several hundreds of milliseconds.

However, since the second section of the pixel electrode in an SPVA LCD is electrically floated, (i.e. the second section is electrically isolated from the first section, thin film transistor, and data lines), charges stored in the second section of the pixel electrode may not be properly discharged.

As these charges may not be easily discharged, a voltage having the same polarity may be continuously applied to the liquid crystal. Thus, an after image may remain on the LCD panel even when the LCD panel is off, and flicker may occur during the operation of the LCD panel.

### SUMMARY OF THE INVENTION

The present invention provides a display panel that may be capable of improving brightness and side visibility.

Additional features of the invention will be set forth in the description which follows, and in part will be apparent from the description, or may be learned by practice of the invention.

The present invention discloses a display panel including a plurality of gate lines to receive a gate pulse having a gate on voltage and a gate off voltage, a plurality of data lines crossing and insulated from the gate lines to receive a first data voltage, and a plurality of pixels respectively disposed in a plurality of pixel areas defined by the gate lines and the data lines. A pixel includes a first thin film transistor, a first liquid crystal capacitor, a coupling capacitor, a second liquid crystal capacitor, and a discharge circuit. The first thin film transistor is connected to an n^{th} gate line and an m^{th} data line to output the first data voltage in response to the gate pulse having the gate on voltage, where n and m are natural numbers. The first liquid crystal capacitor is connected to the first thin film transistor to charge the first data voltage as a main pixel voltage, the coupling capacitor is connected in parallel to the first liquid crystal capacitor to receive the first data voltage, and the second liquid crystal capacitor is connected to the coupling capacitor in series to charge a second data voltage as a sub-pixel voltage. The second data voltage is lower than the first data voltage. The discharge circuit is connected between the coupling capacitor and the second liquid crystal capacitor to form a discharge path of charges stored in the second liquid crystal capacitor.

The present invention also discloses a display panel including an array substrate having a plurality of gate lines to receive a gate pulse, a plurality of data lines crossing and insulated from the gate lines, and a plurality of pixels respectively disposed in a plurality of pixel areas defined by the gate lines and the data lines. The gate pulse has a gate on voltage and a gate off voltage, and the data lines receive a first data voltage. An opposite substrate is coupled with the array substrate while facing the array substrate. The opposite substrate includes a common electrode, and a liquid crystal layer is interposed between the array substrate and the opposite substrate. A pixel includes a first thin film transistor, a main pixel electrode, a sub-pixel electrode, and a second thin film transistor. The first thin film transistor is connected to an n^{th} gate line and an m^{th} data line to output the first data voltage in response to the gate pulse having a gate on voltage. The main pixel electrode is connected to a first drain electrode of the first thin film transistor to receive the first data voltage as a main pixel voltage, and the sub-pixel electrode is spaced apart from the main pixel electrode and partially overlaps with the first drain electrode to receive a second data voltage lower than the first data voltage as a sub-pixel voltage. The second thin film transistor is connected to the sub-pixel electrode to form a discharge path of voltage of the sub-pixel electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an equivalent circuit diagram of a (n×m)-th pixel included in a display panel according to an exemplary embodiment of the present invention.

FIG. 2 and FIG. 3 are graphs showing waveforms for the equivalent circuit of FIG. 1.

FIG. 4 shows a layout of the pixel of FIG. 1.

FIG. 5 is a cross-sectional view taken along line I-I′ of FIG. 4.

FIG. 6 is a cross-sectional view taken along line II-II′ of FIG. 4.

FIG. 7 is a cross-sectional view taken along line III-III′ of FIG. 4.

FIG. 8 is an equivalent circuit diagram of a (n×m)-th pixel included in a display panel according to another exemplary embodiment of the present invention.

FIG. 9 shows a layout of the pixel of FIG. 8.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

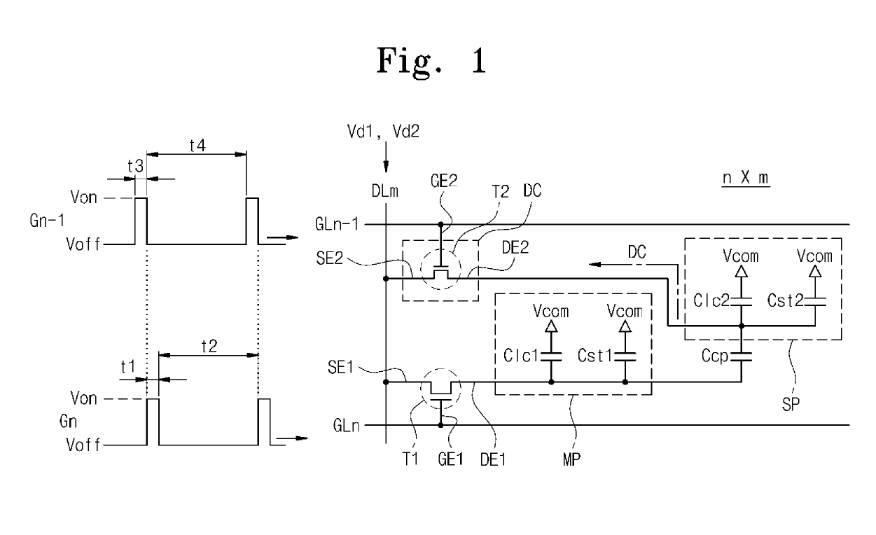

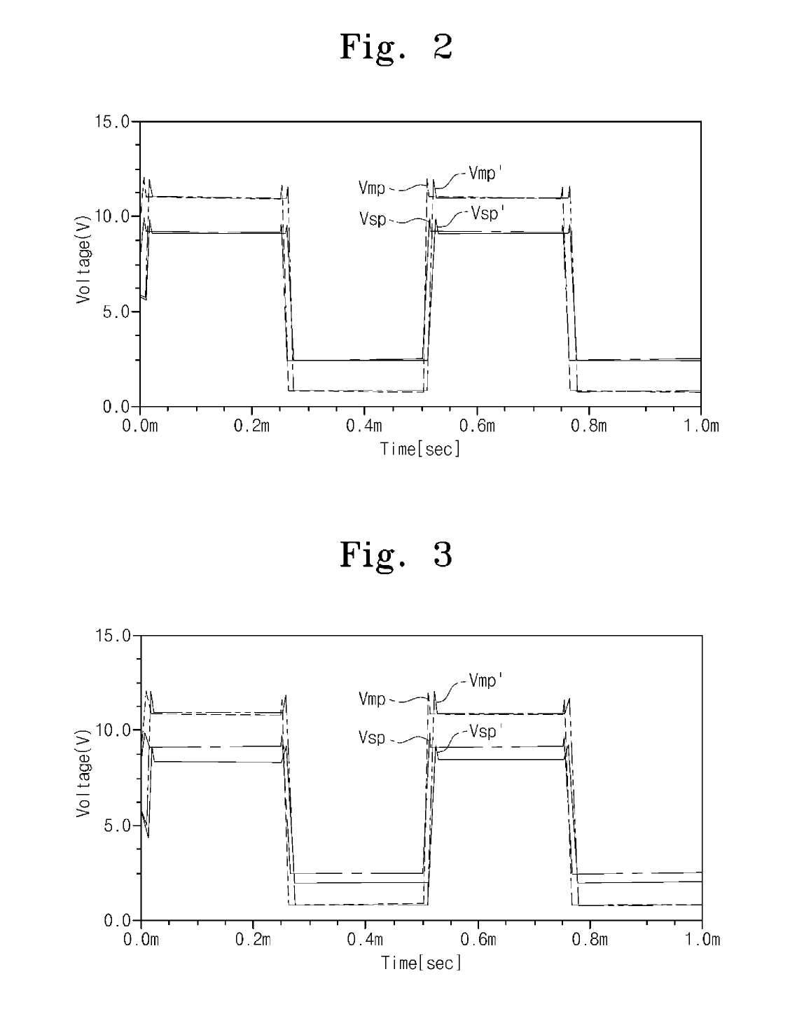

FIG. 1 is an equivalent circuit diagram of a (n×m)-th pixel included in a display panel according to an exemplary embodiment of the present invention, and FIG. 2 is a graph showing waveforms for the equivalent circuit of FIG. 1.

Referring to FIG. 1 and FIG. 2, the (n×m)-th pixel includes an n^{th} gate line GLₙ, an m^{th} data line DLₘ, a first thin film transistor T1, and a discharge circuit DC. The first thin film transistor T1 is connected to the n^{th} gate line GLₙ and the m^{th} data line DLₘ.

Specifically, a first gate electrode GE1 of the first thin film transistor T1 is connected to the n^{th} gate line GLₙ, and a first source electrode SE1 thereof is connected to the m^{th} data line DLₘ. The first thin film transistor T1 also includes a first drain electrode DE1.

When a gate pulse Gₙᵢ is applied to the n^{th} gate line GLₙ, a data voltage V_{d1} is applied to the m^{th} data line DLₘ. The gate pulse Gₙᵢ includes a gate on voltage Vₒₙ that is maintained for a first time interval t1 and a gate off voltage V_{off} that is maintained for a second time interval t2. The second time interval t2 follows the first time interval t1.

As the first thin film transistor T1 is turned on in response to the gate pulse Gₙᵢ in the first time interval t1, the data voltage V_{d1} applied to the first source electrode SE1 is output to the first drain electrode DE1.

After the first time interval t1, the first thin film transistor T1 is turned off in response to the gate pulse Gₙᵢ in the state of the gate off voltage V_{off} corresponding to the second time interval t2.

The discharge circuit DC is connected to a (n−1)^{th} gate line GL₍ₙ₋₁₎ and the (m)^{th} data line DL₍ₘ₎.

Specifically, the discharge circuit DC includes a second thin film transistor T2 having a second gate electrode GE2 connected to the (n−1)^{th} gate line GL₍ₙ₋₁₎ and a second source electrode SE2 connected to the m^{th} data line DLₘ. The second thin film transistor T2 also includes a second drain electrode DE2.

When the gate pulse G₍ₙ₋₁ᵢ₎ is applied to the (n−1)^{th} gate line GL₍ₙ₋₁₎, the data voltage V_{d2} is applied to the m^{th} data line DLₘ. The gate pulse G₍ₙ₋₁ᵢ₎ includes the gate on voltage Vₒₙ that is maintained for a third time interval t3 and the gate off voltage V_{off} that is maintained for a fourth time interval t4. The fourth time interval t4 follows the third time interval t3.

As the second thin film transistor T2 is turned on in response to the gate pulse G₍ₙ₋₁ᵢ₎ in the third time interval t3, the data voltage V_{d2} applied to the second source electrode SE2 is output to the second drain electrode DE2.

After the third time interval t3, the second thin film transistor T2 is turned off in the fourth time interval t4.

The (n×m)-th pixel further includes a main pixel MP, a coupling capacitor C_{cp}, and a sub-pixel SP. The main pixel MP is connected in parallel to the coupling capacitor C_{cp} through the first drain electrode DE1 of the first thin film transistor T1, and the coupling capacitor C_{cp} is connected to the sub-pixel SP in series.

The main pixel MP includes a first liquid crystal capacitor C_{lc1} and a first storage capacitor Cₛₜ₁, which are connected in parallel to the first drain electrode DE1.

Specifically, the first end of the first liquid crystal capacitor C_{lc1} is connected to the first drain electrode DE1 of the first thin film transistor T1, and the second end thereof is connected to the common electrode to which a common voltage V_{com} is applied. The first end of the first storage capacitor Cₛₜ₁ is connected to the first end of the first liquid crystal capacitor C_{1c1}, and the second end thereof is connected to the common electrode.

The coupling capacitor C_{cp} is connected between the main pixel MP and the sub-pixel SP. That is, the first end of the coupling capacitor C_{cp} is connected to the first drain electrode DE1 and the second end thereof is connected to the sub-pixel SP.

The sub-pixel SP includes a second liquid crystal capacitor C_{1c2} and a second storage capacitor Cₛₜ₂ connected to the second end of the coupling capacitor C_{cp} in parallel with each other.

Particularly, the first end of the second liquid crystal capacitor C_{lc2} is connected to the second end of the coupling capacitor C_{cp}, and the second end of the second liquid crystal capacitor C_{lc2} is connected to the common electrode. The first end of the second storage capacitor Cₛₜ₂ is connected to the second end of the coupling capacitor C_{cp}, and the second end of the second storage capacitor Cₛₜ₂ is connected to the common electrode. Further, the first end of the second liquid crystal capacitor C_{lc2} and the first end of the second storage capacitor Cₛₜ₂ are also connected to the second drain electrode DE2 of the second thin film transistor T2 included in the discharge circuit DC.

As the gate on voltage Vₒₙ is applied to the n^{th} gate line GLₙ, the first thin film transistor T1 is turned on, so that the data voltage V_{d1} applied to the data line DLₘ is output to the first drain electrode DE1. The data voltage V_{d1} output to the first drain electrode DE1 is charged in the first liquid crystal capacitor C_{lc1} of the main pixel MP and the second liquid crystal capacitor C_{lc2} of the sub-pixel SP. However, the voltage charged in the second liquid crystal capacitor C_{lc2} of the sub-pixel SP is smaller than that charged in the first liquid crystal capacitor C_{lc1} of the main pixel MP due to the coupling capacitor C_{cp}.

Liquid crystal molecules of the second liquid crystal capacitor C_{lc2} are tilted less than liquid crystal molecules of the first liquid crystal capacitor C_{lc2} due to the difference in voltages charged in the first liquid crystal capacitor C_{lc1} and the second liquid crystal capacitor C_{1c2}. As light passing through the main pixel MP and the sub-pixel SP is combined, the side viewing angle may be improved without degrading brightness in front of the LCD.

In a conventional display panel, unlike the display panel of FIG. 1, as the gate pulse Gₙᵢ in the state of the gate off voltage is applied to the n^{th} gate line GLₙ, the first thin film transistor T1 is turned off and serves as a resistor. Thus, the first liquid crystal capacitor C_{lc1} may be discharged to the exterior through the m^{th} data line DLₘ due to the first thin film transistor T1. However, since the second liquid crystal capacitor C_{lc2} is floated by the coupling capacitor C_{cp}, the second liquid crystal capacitor C_{lc1} may not be discharged to the exterior.

However, according to the display panel of FIG. 1, the first end of the second liquid crystal capacitor C_{lc1} is connected to the second thin film transistor T2 of the discharge circuit DC, thereby providing a discharge path for the second liquid crystal capacitor C_{lc2}.

More specifically, as the gate pulse Gₙᵢ in the state of the gate off voltage V_{off} is applied to the n^{th} gate line GLₙ, the first thin film transistor T1 is turned off. In this case, since the (n−1)^{th} gate line GL₍ₙ₋₁₎ is also maintained in the gate off voltage V_{off}, the second thin film transistor T2 in the discharge circuit DC is also turned off.

Accordingly, the second thin film transistor T2 also serves as a resistor that connects the first end of the second liquid crystal capacitor C_{lc2} to the m^{th} data line DLₘ. As a result, the second liquid crystal capacitor C_{lc2} may also be discharged to the exterior due to the second thin film transistor T2.

As the gate pulse G₍ₙ₋₁ᵢ₎ in the state of the gate on voltage Vₒₙ is applied to the (n−1)^{th} gate line GL₍ₙ₋₁₎, the second thin film transistor T2 in the discharge circuit DC is turned on. Accordingly, a predetermined amount of charges is previously charged in the second liquid crystal capacitor C_{lc2} due to the data voltage V_{d2}. If excessive charges are charged in the second liquid crystal capacitor C_{lc2} in advance, the discharge may not be sufficiently performed for the short time interval t2 during which the gate off voltage V_{off} of the n^{th} gate line GLₙ is maintained. In order to minimize the amount of charges that may be stored in the second liquid crystal capacitor C_{lc2}, the size, i.e. driving performance of the second thin film transistor T2 may be adjusted. Specifically, the second thin film transistor T2 may be designed to have a size that is 20% or less of the size of the first thin film transistor T1. For example, when the size of a transistor is defined as W/L (W and L denote channel width and channel length, respectively), the second thin film transistor T2 may be designed to have a size that is 20% or less of the size of the first thin film transistor T1.

FIG. 2 and FIG. 3 are graphs showing voltage waveforms for the main pixel MP and the sub-pixel SP included in the display panel according to an exemplary embodiment of the present invention. FIG. 2 shows a waveforms of the main pixel voltage Vₘₚ and the sub-pixel voltage Vₛₚ during normal operation in a (n×m)-th pixel having no discharge circuit. FIG. 2 also shows a waveforms of the main pixel voltage V_{mp′} and the sub-pixel voltage V_{sp′} during normal operation in the (n×m)-th pixel having the discharge circuit with the second thin film transistor T2 with a size that is 20% or less of the size of the first thin film transistor T1. FIG. 3 shows a waveforms of the main pixel voltage Vₘₚ and the sub-pixel voltage Vₛₚ during normal operation in a (n×m)-th pixel having no discharge circuit. FIG. 3 also shows a waveforms of the main pixel voltage V_{mp′} and the sub-pixel voltage V_{sp′} during normal operation in the (n×m)-th pixel having the discharge circuit with the second thin film transistor T2 with a size that is more than 20% of the size of the first thin film transistor T1.

As shown in FIG. 2, although each pixel has the discharge circuit including the second thin film transistor T2, no problems occur in normal operation. However, when the second thin film transistor T2 has a size that is more than 20% of the size of the first thin film transistor T1, a voltage difference may occur between the sub-pixel voltage V_{sp′} and Vₛₚ as shown in FIG. 3. Accordingly, the second thin film transistor T2 may be designed to have a size that is 20% or less of the size of the first thin film transistor T1 as described above.

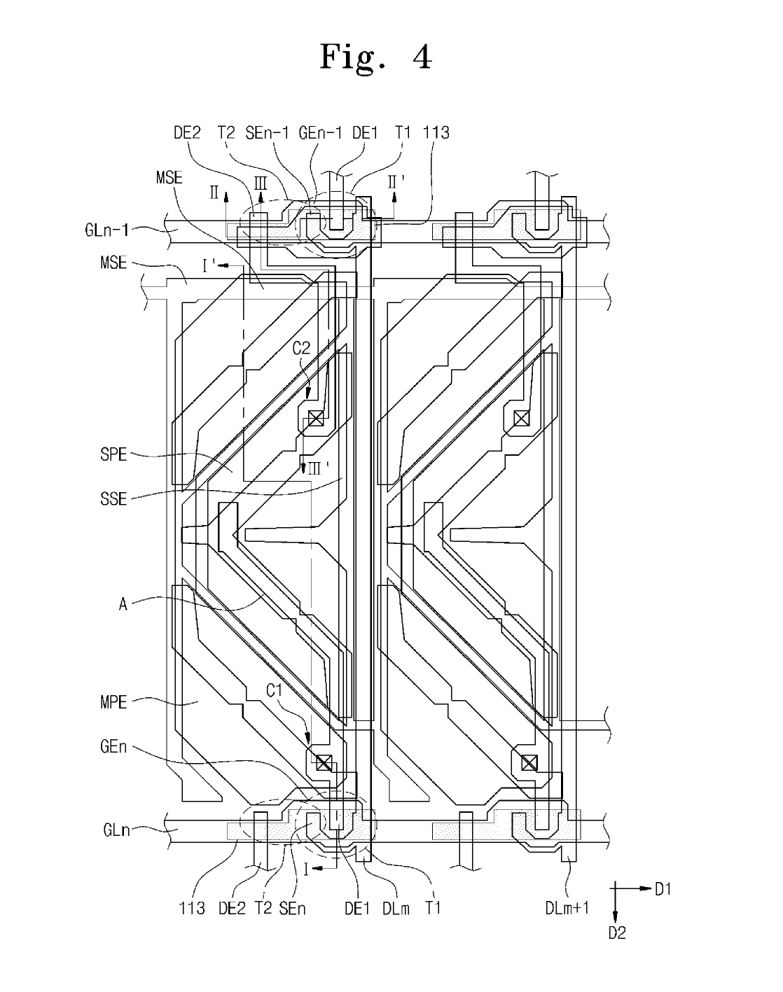

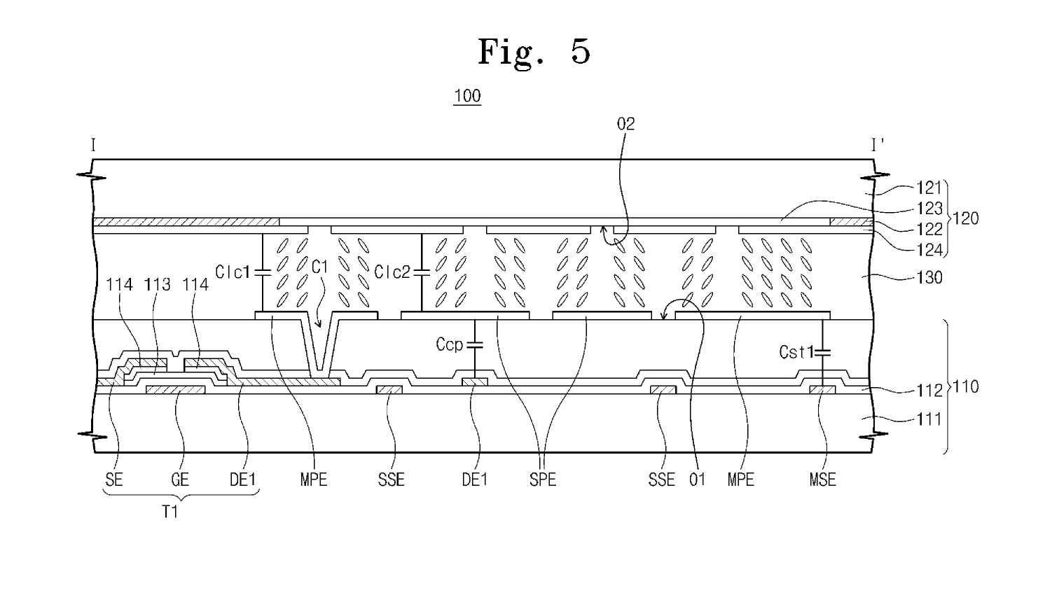

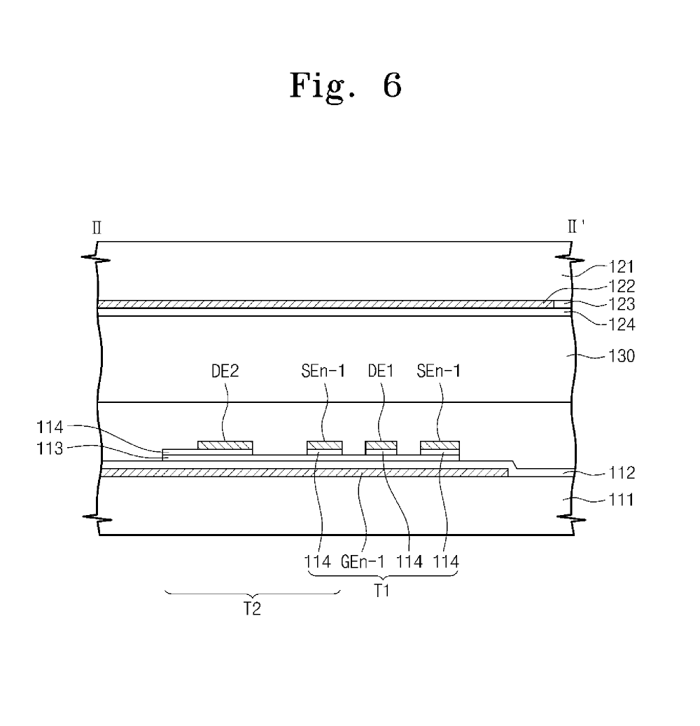

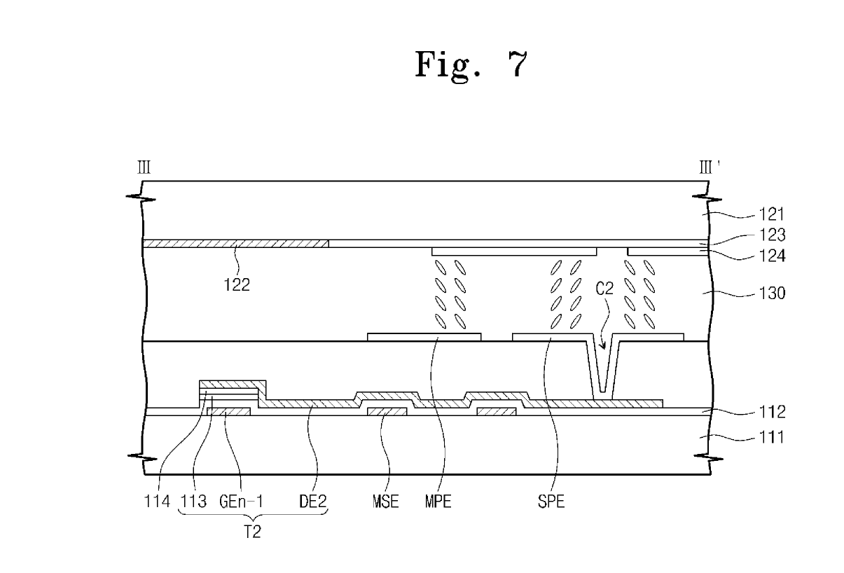

FIG. 4 is a layout of the (n×m)-th pixel of FIG. 1, FIG. 5 is a cross-sectional view taken along line I-I′ of FIG. 4, FIG. 6 is a cross-sectional view taken along line II-II′ of FIG. 4, and FIG. 7 is a cross-sectional view taken along line III-III′ of FIG. 4.

Referring to FIG. 4 and FIG. 5, the display panel 100 includes an array substrate 110, an opposite substrate 120 coupled to the array substrate 110 while facing the array substrate 110, and a liquid crystal layer 130 interposed between the array substrate 110 and the opposite substrate 120.

The array substrate 110 includes a first base substrate 111, and the gate and data lines GLₙ, GLₙ₋₁, _{. . .} and DLₘ, DLₘ₊₁, _{. . .} are formed on the first base substrate 111. The gate lines GLₙ, GLₙ₋₁, _{. . .} extend in the first direction D1, and the data lines DLₘ, DLₘ₊₁, _{. . .} extend in the second direction D2, which is substantially perpendicular to the first direction D1. Further, the data lines DLₘ, DLₘ₊₁, _{. . .} cross with and are insulated from the gate lines GLₙ, GLₙ₋₁, _{. . .} , so that a plurality of pixel areas are defined by the gate and data lines GLₙ, GLₙ₋₁, _{. . .} and DLₘ, DLₘ₊₁, _{. . .} .

A gate insulating layer 112, semiconductor islands 113, and ohmic contact islands 114 are arranged on the first base substrate 111.

The semiconductor islands 113 may be hydrogenated amorphous silicon or polysilicon, and the ohmic contact islands 114 may be amorphous silicon doped with a high concentration of an impurity, polysilicon, or silicide. The ohmic contact islands 114 are disposed in pairs on the semiconductor islands 113.

Each pixel area includes the first thin film transistor T1, the second thin film transistor T2, the main pixel MP, and the sub-pixel SP.

Referring to FIG. 5, the first thin film transistor T1 is connected to the gate and data lines GLₙ, and DLₘ. The gate electrode GE of the first thin film transistor T1 branches from the gate line GLₙ and the source electrode SE thereof branches from the data line DLₘ. The first drain electrode DEL of the first thin film transistor T1 is connected to the main pixel MP.

The thin film transistor T1 outputs a data voltage, which is applied through the data line DLₘ, to the first drain electrode DE1 in response to the gate pulse applied through the gate line GLₙ.

The main pixel MP includes a main pixel electrode MPE and a main storage electrode MSE, and the sub-pixel SP includes a sub-pixel electrode SPE and a sub-storage electrode SSE. The main pixel electrode MPE and the sub-pixel electrode SPE have sizes that are different from each other. A lateral side of the main pixel electrode MPE and the sub-pixel electrode SPE, which is parallel with the data line DLₘ, may be bent in the first direction D1, that is, the extending direction of the gate line GLₙ.

The main pixel electrode MPE is connected to the first drain electrode DE1 of the first thin film transistor T1 through a first contact hole C1, and it receives the data voltage.

The sub-pixel electrode SPE overlaps with an extended part A of the first drain electrode DE1 to form the coupling capacitor C_{cp}.

The main pixel electrode MPE is spaced apart from the sub-pixel electrode SPE. Accordingly, the main pixel electrode MPE is capacitively coupled to the sub-pixel electrode SPE during the first time interval t1 (see FIG. 1) in which the gate pulse Gni in the state of the gate on voltage Vₒₙ is applied to the first thin film transistor T1. After the first time interval t1, as the first thin film transistor T1 is turned off during the second time interval t2, the main pixel electrode MPE is electrically isolated from the sub-pixel electrode SPE. In the present exemplary embodiment, an area between the main pixel electrode MPE and the sub-pixel electrode SPE in one pixel area corresponds to an area without a pixel electrode, and will be defined as a first opening O1.

The main storage electrode MSE and the sub-storage electrode SSE are integrally formed with each other, and overlap with the main pixel electrode MPE and the sub-pixel electrode SPE, respectively. In detail, the main storage electrode MSE extends in the first direction D1 and partially overlaps with the main pixel electrode MPE. The main pixel electrode MPE partially overlaps with the main storage electrode MSE to form the first storage capacitor Cₛₜ₁.

The sub-storage electrode SSE extends in the second direction D2 while interposing the main storage electrode MSE, and partially overlaps with the sub-pixel electrode SPE. The sub-pixel electrode SPE overlaps with the sub-storage electrode SSE to form the second storage capacitor Cₛₜ₂. The common voltage Vcom is applied to the main storage electrode MSE and the sub-storage electrode SSE.

Referring to FIG. 4, FIG. 6 and FIG. 7, the second thin film transistor T2 is connected to the (n−b 1)^{th} gate GLₙ₋₁ and the m^{th} data line DLₘ. The gate electrode GE₍ₙ₋₁₎ of the second thin film transistor T2 branches from the (n−1)^{th} gate line GL₍ₙ₋₁₎ and the source electrode SE₍ₙ₋₁₎ thereof branches from the data line DLₘ. The second drain electrode DE2 of the second thin film transistor T2 is spaced apart from the source electrode SE₍ₙ₋₁₎ by a predetermined interval. Further, the second drain electrode DE2 partially extends to be connected to the sub-pixel electrode SPE through a second contact hole C2. Accordingly, the second liquid crystal capacitor C_{lc2} including the sub-pixel electrode SPE is connected to the second thin film transistor T2, thereby providing a discharge path for the second liquid crystal capacitor C_{lc2}.

The second thin film transistor T2 shares the gate electrode GE₍ₙ₋₁₎ of the first thin film transistor T1 that is connected to the (n−1)^{th} gate line GL₍ₙ₋₁₎, as well as the source electrode SE₍ₙ₋₁₎ and the semiconductor layer 113. Accordingly, since the second thin film transistor T2 and the first thin film transistor T1 may be substantially simultaneously formed through the same process, an additional process of forming the second thin film transistor T2 is not required.

Referring to FIG. 5, the opposite substrate 120 includes a second base substrate 121, a black matrix 122, a color filter layer 123, and a common electrode 124.

The black matrix 122 includes a light blocking material and is formed on the second base substrate 121. The black matrix 122 is formed in a non-effective area of one pixel to prevent light leakage.

The color filter layer 123 includes red, green, and blue color filters and is formed in an effective area of one pixel.

The common electrode 124 is formed over the whole area of the black matrix 122 and the color filter layer 123. A plurality of second openings O2 may be formed in the common electrode 124 through a patterning process. The second openings O2 are formed at different positions than the first openings O1. Also, each first opening O1 is located between two adjacent second openings O2.

The first and second openings O1 and O2 form a plurality of domains, in which the liquid crystal molecules are aligned in different directions, in one pixel area. As described above, the liquid crystal molecules are aligned in different directions in the different domains, so that a change in visibility in accordance with a viewing angle is reduced due to the mutual compensation effect between the domains. Therefore, the display apparatus may have a wider viewing angle.

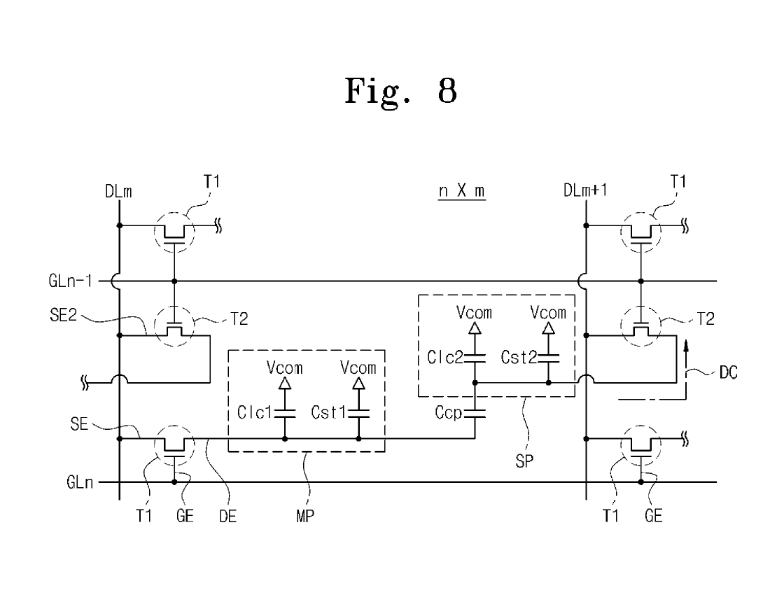

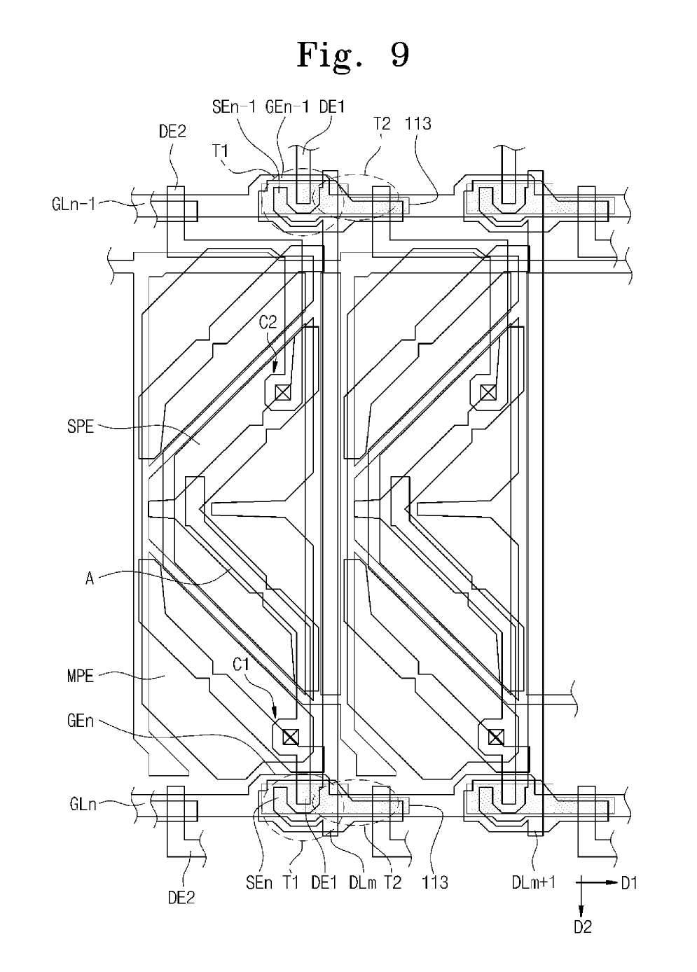

FIG. 8 is an equivalent circuit diagram of a (n×m)-th pixel included in a display panel according to another exemplary embodiment of the present invention, and FIG. 9 is a layout of the pixel of FIG. 8.

In FIG. 8 and FIG. 9, the same reference numerals denote the same elements in FIG. 1 and FIG. 4, and thus the detailed descriptions of the same elements will be omitted.

Referring to FIG. 8 and FIG. 9, the (n×m)-th pixel includes an n^{th} gate line GLₙ, an m^{th} data line DLₘ, a first thin film transistor T1, and a discharge circuit DC. The first thin film transistor T1 is connected to the n^{th} gate line GLₙ and the m^{th} data line DLₘ. The discharge circuit DC includes a second thin film transistor T2.

The display panel of FIG. 8 and FIG. 9 provides a different discharge path for the second liquid crystal capacitor C_{lc2} than that of the previous embodiment.

In detail, the discharge path of the second liquid crystal capacitor C_{lc2} is formed through the second thin film transistor T2 that is connected to a (n−1)^{th} gate line and a (m+1)^{th} data line. That is, when the first thin film transistor T1 is turned off in response to a gate pulse Gni in the state of the gate off voltage Voff, the discharge of charges stored in the second liquid crystal capacitor C_{lc2} starts through the (m+1)^{th} data line.

As described above, the discharge path of the electrically floated second liquid crystal capacitor is formed in the display panel, so that the charges stored in the second liquid crystal capacitor may be effectively discharged.

Thus, the display panel may prevent the after image on a display screen caused by charges stored in the second liquid crystal capacitor, thereby improving the display quality of the display panel.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display panel, comprising:
a plurality of gate lines to receive a gate pulse comprising a gate on voltage and a gate off voltage;
a plurality of data lines crossing and insulated from the gate lines, the data lines to receive a first data voltage; and
a plurality of pixels respectively disposed in a plurality of pixel areas defined by the gate lines and the data lines,
wherein a pixel comprises:
a first thin film transistor connected to an n^{th} gate line and an m^{th} data line to output the first data voltage in response to the gate pulse having the gate on voltage, n and m being natural numbers;
a first liquid crystal capacitor connected to the first thin film transistor to charge the first data voltage as a main pixel voltage;
a coupling capacitor connected in parallel to the first liquid crystal capacitor to receive the first data voltage;
a second liquid crystal capacitor connected to the coupling capacitor in series to charge a second data voltage as a sub-pixel voltage, the second data voltage being lower than the first data voltage; and
a discharge circuit connected between the coupling capacitor and the second liquid crystal capacitor to form a discharge path of charges stored in the second liquid crystal capacitor.

2. The display panel of claim 1, wherein the discharge circuit comprises a second thin film transistor.

3. The display panel of claim 2, wherein the first thin film transistor comprises:
a first gate electrode connected to the n^{th} gate line;
a first source electrode connected to the m^{th} data line; and
a first drain electrode,
wherein the second thin film transistor comprises:
a second gate electrode connected to an (n−1)^{th} gate line;
a second source electrode connected to the m^{th} data line; and
a second drain electrode connected between the coupling capacitor and the second liquid crystal capacitor.

4. The display panel of claim 3, wherein the discharge path comprises the second thin film transistor and the m^{th} data line.

5. The display panel of claim 3, wherein a discharge of the charges stored in the second liquid crystal capacitor starts when the first thin film transistor is turned off in response to the gate pulse having the gate off voltage.

6. The display panel of claim 2, wherein the first thin film transistor comprises:
a first gate electrode connected to the n^{th} gate line;
a first source electrode connected to the m^{th} data line; and
a first drain electrode,
wherein the second thin film transistor comprises:
a second gate electrode connected to an (n−1)^{th} gate line;
a second source electrode connected to an (m+1)^{th} data line; and
a second drain electrode connected between the coupling capacitor and the second liquid crystal capacitor.

7. The display panel of claim 6, wherein the discharge path comprises the second thin film transistor and the (m+1)^{th} data line.

8. The display panel of claim 2, wherein W/L of the second thin film transistor is 20% or less of W/L of the first thin film transistor, W being a channel width and L being a channel length of the thin film transistor.

9. The display panel of claim 1, wherein the pixel further comprises:
a first storage capacitor connected in parallel to the first liquid crystal capacitor; and
a second storage capacitor connected in parallel to the second liquid crystal capacitor.

10. A display panel, comprising:
an array substrate comprising a plurality of gate lines to receive a gate pulse, a plurality of data lines crossing and insulated from the gate lines, and a plurality of pixels respectively disposed in a plurality of pixel areas defined by the gate lines and the data lines, in which the gate pulse comprises a gate on voltage and a gate off voltage, and the data lines receive a first data voltage;
an opposite substrate coupled with the array substrate while facing the array substrate, the opposite substrate comprising a common electrode; and
a liquid crystal layer interposed between the array substrate and the opposite substrate,
wherein a pixel comprises:
a first thin film transistor connected to an n^{th} gate line and an m^{th} data line to output the first data voltage in response to the gate pulse having a gate on voltage;
a main pixel electrode connected to a first drain electrode of the first thin film transistor to receive the first data voltage as a main pixel voltage;
a sub-pixel electrode spaced apart from the main pixel electrode and partially overlapping with the first drain electrode to receive a second data voltage lower than the first data voltage as a sub-pixel voltage; and
a second thin film transistor connected to the sub-pixel electrode to form a discharge path of voltage of the sub-pixel electrode.

11. The display panel of claim 10, wherein the first thin film transistor comprises:
a first gate electrode branching from the n^{th} gate line; and
a first source electrode disposed on the first gate electrode, the first source electrode branching from the m^{th} data line;
wherein the second thin film transistor comprises:
a second gate electrode branching from an (n−1)^{th} gate line;
a second source electrode disposed on the second gate electrode, the second source electrode branching from the m^{th} data line; and
a second drain electrode spaced apart from the second source electrode and connected to the sub-pixel electrode.

12. The display panel of claim 11, wherein the discharge path comprises the second thin film transistor and the m^{th} data line.

13. The display panel of claim 10, wherein the first thin film transistor comprises:
a first gate electrode branching from the n^{th} gate line; and
a first source electrode disposed on the first gate electrode, the first source electrode branching from the m^{th} data line;
wherein the second thin film transistor comprises:
a second gate electrode branching from an (n−1)^{th} gate line;
a second source electrode disposed on the second gate electrode, the second source electrode branching from an (m+1)^{th} data line; and
a second drain electrode spaced apart from the second source electrode and connected to the sub-pixel electrode.

14. The display panel of claim 13, wherein the discharge path comprises the second thin film transistor and the (m+1)^{th} data line.

15. The display panel of claim 10, wherein the pixel further comprises:
a main storage electrode partially overlapping with an edge of the main pixel electrode; and
a sub-storage electrode partially overlapping with an edge of the sub-pixel electrode.

16. The display panel of claim 15, wherein the main storage electrode is integrally formed with the sub-storage electrode.

17. The display panel of claim 10, wherein the first thin film transistor and the second thin film transistor are substantially simultaneously formed through the same process.

18. The display panel of claim 17, wherein W/L of the second thin film transistor is 20% or less of W/L of the first thin film transistor, W being a channel width and L being a channel length of the thin film transistor.
